(19) United States
(12) Patent Application Publication
(10) Pub. No.: US 2007/0300264 A1
(43) Pub. Date: Dec. 27, 2007

(54) INTERACTIVE MUSIC AND VIDEO DELIVERY METHOD AND SYSTEM

(76) Inventor: Gary Turner, Parker, CO (US)

Correspondence Address: SHERIDAN ROSS PC, 1560 BROADWAY, SUITE 1200, DENVER, CO, 80202, US

(21) Appl. No.: 11/552,047

(22) Filed: Oct. 23, 2006

Related U.S. Application Data
(63) Continuation-in-part of application No. 11/425,652, filed on Jun. 21, 2006.

(51) Int. Cl. H04N 7/173; H04N 7/16; H04N 5/445; G06F 13/00

(52) U.S. Cl. 725/60; 725/135; 725/112; 725/113; 725/136

(57) ABSTRACT

Methods and apparatuses for providing enhanced advertising media are described herein. In particular, interactive music and music videos can be provided to a viewer of a television (TV) upon the request of the viewer. Additionally, the viewer can choose which music and/or music videos he/she would like to view at a particular time as well as order such music and/or music videos.

### CROSS-REFERENCE TO RELATED APPLICATIONS

This application is a Continuation-in-Part of U.S. patent application Ser. No. 11/425,652 filed Jun. 21, 2006, the entire application being incorporated herein by reference.

### FIELD

The present invention is directed to interactive medias and more specifically methods and apparatuses for providing an interactive music and video program through a television medium.

### BACKGROUND

With the advent of the Internet, the use of Personal Computers (PCs) to view and interact with music, videos, and other media has expanded. One of the main uses for PCs is to download and listen to music and music videos. Currently, a person can log on to any one of a number of websites that offer media such as music and videos for download. Once logged on, the person can choose to download virtually any song from the website that has been recorded and saved in an electronic format. When the song has been downloaded to the person's PC, that person can listen to the song at his/her leisure.

Since the PC has emerged as the primary vehicle to download and interact with media such as music, videos, televisions shows, and the like, various applications have also been developed for the PC to further enhance the interaction with such media. For example, there are a number of media player applications such as Windows Media Player® as distributed by Microsoft® Corporation, Winamp® as distributed by Nullsoft®, and iTunes® as distributed by Apple® Computer, Inc. to name a few.

In addition to the development of PC based applications for interaction with media, many hardware devices have been developed to make the media portable once it is downloaded to a person's PC. These hardware devices allow a person to carry and access up to thousands of songs any time they wish. It is inevitable that new hardware devices and software applications will continue to be developed as there is a great amount of interest in having access to various types of media on demand.

As the technologies surrounding the PC have been heavily developed to provide users with interactive media solutions, there has been little attention paid to Interactive Television (ITV). Rather, in the past, TV has been used as a one-way medium in which the television network decides what programs will be shown at what times. Even with these restrictions TV has proven to be the worlds most popular media delivery device. However, due to certain limitations TV technology has not been cultivated to the extent that PC technology has.

The technology of ITV has been developed in an attempt to allow a TV set to serve as a two-way information distribution mechanism. Features of an ITV accommodate a variety of marketing, entertainment, and educational capabilities. Typically, the interactive functionality is controlled by a “set-top” decoder box (“set-top box” or “STB”), which executes an interactive program written for the TV broadcast. The interactive functionality is often displayed on the TV's screen and may include icons or menus to allow a user to make selections via the TV's remote control or a keyboard.

The program interactivity may be optional. Thus, a user who chooses not to interact or who does not have interactive functionality included with the user's TV should not suffer any degradation or interruption in program content. In order to provide this option to users, a transparent method of incorporating interactive content into the broadcast stream that carries the program is employed. In the present disclosure, “broadcast stream” or “live broadcast” refers to the broadcast signal, whether analog or digital, regardless of the method of transmission of that signal, i.e. by antenna, satellite, cable, or any other method of analog or digital signal transmission.

One method of transparently incorporating interactive content into the broadcast stream is the insertion of triggers into the broadcast stream for a particular program. The insertion of “triggers” into a broadcast stream is well known in the art. Program content in which such triggers have been inserted is sometimes referred to as enhanced program content or as an enhanced TV program or video signal.

Triggers may be used to alert a STB that interactive content is available. The trigger may contain information about available enhanced content as well as the memory location of the enhanced content. A trigger may also contain user-perceptible text that is displayed on the screen, for example, at the bottom of the screen, which may prompt the user to perform some action or choose amongst a plurality of options. Thus, a user with a TV that has interactive functionality may be prompted at the beginning of an enhanced TV program to choose between interactive and passive (non-interactive) viewing of the enhanced TV program. If the user chooses passive viewing, any further triggers contained in the enhanced TV program may be ignored by the STB and the user will view the program in a conventional way. However, if the user chooses the interactive option, then further triggers may be embedded in the enhanced TV program.

Triggers may be inserted into the broadcast stream at various points along the broadcast path. Triggers may be inserted into the broadcast stream before broadcast of the content by a broadcast station or any other media provider. Thus, these triggers would be part of the broadcast stream received by cable head ends and further distributed to TVs within homes. TVs are provided with interactive functionality by their associated STBs.

One common method for inserting data such as triggers into an analog video signal is the placement of that data into the unused lines of the video signal that make up the vertical blanking interval (VBI). Closed caption text data is a well known example of the placement of data in the VBI of the video signal. The closed caption text data is typically transmitted during line 21 of either the odd or even field of the video frame in a National Television Standards Committee (NTSC) format. Closed caption decoders strip the encoded text data from the video signal, decode the text data, and reformat the data for display, concurrent with the video data, on a TV screen. Such closed caption decoders process the text data separately from the video signal.

The Advanced Television Enhancement Forum (ATVEF) has defined protocols for Hypertext Markup Language (HTML)-based enhanced TV. These protocols allow the delivery of enhanced TV programs to STBs and other devices providing interactive functionality by various transmission means, including, but not limited to, analog, digital, cable, and satellite. For the NTSC format, ATVEF specifies the type of information that may be inserted into the VBI of the video signal and on which lines of the VBI that information may be inserted. ATVEF specifies line 21 of the VBI as the line for insertion of an “ATVEF trigger,” i.e. the information that the STB or other device with interactive functionality interprets to provide interactive features to the enhanced TV program. ATVEF-A triggers comprise a Universal Resource Locator (URL), which provides an Internet address from which interactive content may be downloaded, whereas ATVEF-B triggers themselves can contain interactive content.

While the advent of ATVEF triggers have provided a gateway to interactive television, the complete utilization of ITV and enhanced TV has not been fully realized. For example, the TV has not yet been exploited as a tool for interacting with media such as music and music videos to the extent that the PC has. Rather, the TV has only been used as a medium to show viewers a music video when a network such as MTV® decides that it is time to show the music video. The viewer has not been given the power to choose how and when certain media such as music and music videos should be viewed.

### SUMMARY

The present invention is directed to solving these and other problems and disadvantages of the prior art. In accordance with certain embodiments of the present invention, a method for delivering interactive music and video using a TV is provided. Specifically, the method comprises the steps of:

(a) receiving notification that a first trigger associated with a first music content has been actuated;

(b) receiving notification that a second trigger associated with a first image content has been actuated;

(c) retrieving the first music content and the first image content;

(d) combining the first music content and the first image content into a single program; and

(e) causing the single program to be displayed to a viewer of a display apparatus.

In accordance with another embodiment, a system for delivering interactive music and video content is provided. The system generally comprises the following:

a receiver operable to receive music content and image content from an external source;

a first trigger associated with a first music content;

a second trigger associated with a first image content;

a processor for combining the first music content with the first image content to produce a single program; and

a display apparatus operable to display the single program.

In accordance with one embodiment, the music content may be provided as part of a broadcast. Usually the broadcast is associated with a particular music channel. The channel may be designated to play a certain type of music (e.g., country, hip-hop, rock and roll, blues, etc.). Alternatively, the music content may be a selected song that is being played either from a memory of a STB or directly from a broadcast.

In one embodiment, a user can select various images or image content such as still images, video images, and/or combinations thereof that he/she would like to have displayed along with the selected music or music content. Similar to the music content, the image content may be viewed from memory located on a STB or may be received as part of a live broadcast. In one embodiment, images may be provided as a straight image feed either from the live broadcast or from an external device (e.g., an MP3 player, a camera, camcorder, portable memory device, etc.) and video image content can be stored on a STB and provided therefrom. As can be appreciated, allowing a user to choose images for display with music provides for a more customized music and/or music video experience. The selected music and image can be combined into a single program using an interactive music application. Once combined, the customized single program can be displayed as a seamless unit.

In accordance with at least some embodiments of the present invention, other features may be provided along with the interactive music application. For example, the user may be given the opportunity to purchase various goods and/or services while he/she is using the interactive music application. In one embodiment, the user may be provided the option to purchase the song that is currently playing. In an alternative embodiment, the user can select other songs that are riot currently playing and purchase those songs. Once purchased, the songs can be transmitted from an external server to the STB and stored in a memory of the STB (if the songs are already not resident on the STB memory). The song can then be played from memory and/or transmitted to an external device for storing and/or playing music. However, if the song(s) already resides on the STB memory, then upon confirmation of purchase, the user may be allowed access to download the song(s) from the memory to an external device for storing and/or playing music.

In accordance with another embodiment of the present invention a user is able to create a customized mixture of music and image content (image and/or video) where the music is provided as a part of a television broadcast. The customized music and image content can be recorded for replay at a later time. In one embodiment, triggers may be recorded as a part of the customized music/image experience. The recorded triggers are pointers to content either on the STB or on an external server. The content on the STB or server associated with the recorded triggers may be updated between the time that the music/image experience was recorded and the time the recording is viewed again. Therefore, the second time the same recording is played the same triggers may be displayed but those triggers will correspond to different content. This provides for an updateable TV viewing experience without requiring the user to change any content of the recording.

As used herein “content” includes any type of user-perceptible substance that can incorporate visual and/or audio media. Content is typically in the form of video media or static pages that can be viewed on a TV or the like by a user. Examples of content include, but are not limited to, a live broadcast that may be received from a satellite provider, a cable provider, or over free air, advertisements or information for certain products and/or services, music content, recorded images, computer rendered images, and so on.

The summary is not intended to provide an exhaustive description of all embodiments of the present invention. Namely, additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting a broadcast and display system in accordance with embodiments of the present invention;

FIG. 2 is a screen shot depicting an interactive music menu in accordance with embodiments of the present invention;

FIG. 3 is a flow chart depicting a series of screen shots encountered when initializing interactive music in accordance with embodiments of the present invention;

FIG. 4 is a flow chart depicting a series of screen shots encountered when changing music selections in accordance with embodiments of the present invention;

FIG. 5 is a flow chart depicting a series of informational screen shots in accordance with embodiments of the present invention;

FIG. 6 is a flow chart depicting a method of providing interactive music and images in accordance with embodiments of the present invention;

FIG. 7 is a flow chart depicting a method of retrieving images for display along with music in accordance with embodiments of the present invention; and

FIG. 8 is a flow chart depicting a method of providing purchase selections along with interactive music in accordance with embodiments of the present invention.

### DETAILED DESCRIPTION

Embodiments of the present invention are generally directed toward methods and systems for administering ITV and creating an enhanced TV viewing experience. Although well suited for use with a television or similar type of display apparatus in conjunction with a STB, those skilled in the art can appreciated that embodiments of the present invention may also be implemented in conjunction with a simple television set not including a STB. Moreover, the systems and methods described in the present disclosure may be implemented in any media that may be enhanced through the use of events including, but not limited to, triggers that are synchronized to user-perceptible segments in a broadcast or other type of content.

As used herein “viewer” and “user” are used synonymously to refer to any person or thing that is currently making use of and/or interacting with the enhanced television system.

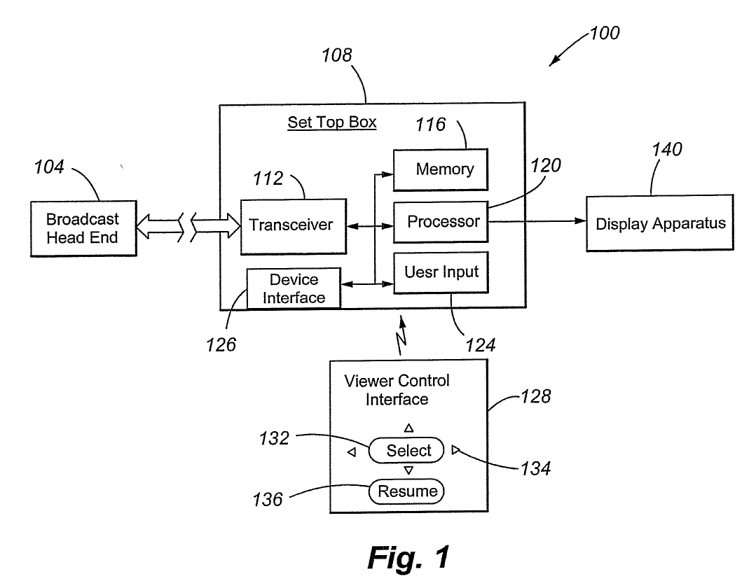

Referring now to FIG. 1, one embodiment of a hardware system 100 for providing interactive media will be described in accordance with embodiments of the present invention. The system 100 generally comprises a broadcast head end 104, a Set Top Box (STB) 108 comprising a transceiver 112, a memory 116, a processor 120, a user input 124, and a device interface 126, a viewer control interface 128 comprising a select button 132, navigation arrows 134, and a resume button 136, and a display apparatus 140. The broadcast head end 104 may be associated with one or more servers that provide information to and receive information from the broadcast head end 104. The broadcast head end 104 may alternatively be associated with a satellite uplink and/or an interactive TV transmission facility. Information that may be provided to the broadcast head end 104 includes live broadcast signals, triggers, content related to the triggers, songs, images, and other streaming or non-streaming video and audio media.

The processor 120 may be implemented as a microprocessor or similar type of processing chip. The processor 120 may complete executable instructions or routines stored in a portion of memory 116. Alternatively, the processor 120 may be implemented in the form of an application specific integrated circuit (ASIC) that is operable to perform predefined functions based on predetermined inputs. The processor 120 generally functions to run programming code including operating system software, and one or more applications implementing various functions performed by the STB 108.

The memory 116 may be implemented as a volatile or non-volatile memory, or combinations thereof. For example, the memory 116 may comprise a temporary or long-term storage of data or processor instructions. The memory 116 may be used in connection with the presentation of enhanced content to a viewer. The memory 116 may comprise solid-state memory resident, removable or remote in nature, such as DRAM, SDRAM, ROM, and EEPROM.

The user input 124 may comprise a receiver for communicating with the viewer control interface 128. The user input 124 may also comprise a keyboard, mouse, a conventional wired or wireless remote control such as TV remote control, a universal remote control, or the like such that the user can navigate content presented to him/her in a similar manner to navigating content on a computer.

The device interface 126 generally provides a communication interface between the STB 108 and portable hardware devices. The portable hardware devices can retrieve data stored on memory 116 and retain such data in their own memory. The device interface 126 can include any type of known device interface such as a Universal Serial Bus (USB) port. Any external hardware device may be equipped to connect to the STB 108 via the device interface 126 and communicate with the STB 108 using known protocols. The device interface 126 may also include any other type of known interface technology such as serial ports and/or parallel ports.

The STB 108 is operable to communicate with the broadcast head end 104 via the transceiver 112. The transceiver 112 is essentially the interface to the head end 104 for the STB 108. The transceiver 112 may comprise a coaxial cable connection, a USB port or other type of serial port, a modem, an Ethernet adapter, a satellite adapter, or the like. Content received at the transceiver 112 is communicated to the processor 120 and/or the memory 116. Content that may be transmitted to the STB 108 includes, but is not limited to, live broadcasts from cable, satellite, or radio waves, songs, music videos, recorded video and static images, computer rendered images, specialized advertisements, triggers, and the like. Typically, recorded video and static images, computer rendered images, and specialized advertisements are stored in the memory 116 when they are received at the transceiver 112. The content is typically stored in a particular address of the memory such that it can be easily retrieved at a later time. In normal operation, content is sent to the STB 108 during idle periods (i.e., when the user is not viewing a live broadcast). However, content can also be sent to the STB 108 during a live broadcast through one or more vertical blanking intervals (VBIs) as packets of information that can be stored in memory 116 while the live broadcast is being displayed.

A trigger usually contains an address, pointer, or some other sort of reference to the stored content or a live broadcast. When a user activates a trigger during a broadcast, the processor 120 uses the address of stored content associated with the trigger to retrieve the content from memory 116. In the event that the content associated with the trigger is a live broadcast, then the trigger references the channel where the live broadcast can be found. Subsequently, the content can be displayed to a user via the display apparatus 140. Thus, multiple pre-stored contents can be maintained in the memory 116 for later display at the appropriate time or a user can navigate multiple live contents via triggers.

Generally, a trigger is transmitted along with a broadcast and both are displayed to a user via the display apparatus 140. A user is able to select the displayed trigger by pressing the select button 132 on the viewer control interface 128. The command to view content associated with the displayed trigger is received at the user input 124. The processor 120 registers the request, determines the address of the stored content in memory 116, and retrieves the associated content from the memory 116. Alternatively, the processor 120 registers the request and determines the address of the live broadcast content on another channel. Thereafter, the requested content is transmitted to the display apparatus 140 for presentation to the user.

A trigger can be transmitted with a broadcast associated with music or music related content. The trigger generally provides a mechanism to view additional content along with current music content or may provide a mechanism to request a particular song. For example, if a user is currently listening to an 80's rock band music station, then the trigger may allow the user to view highlight clips from the 80's. Alternatively, a user may use the trigger to select a particular song that he/she would like to listen to. The selected song can then be transmitted to the memory 116. Thereafter, the song can be played from the memory 116.

In an alternative embodiment, content may not be stored in long-term storage portion of memory 116. Rather, the content may be transmitted along with the broadcast and the associated trigger. The content associated with the trigger may be stored in a memory buffer such that if the user activates the trigger the associated content can be displayed from the buffer. Otherwise, the content is purged from memory to make room for new content. As can be appreciated, a combination of long-term and short-term memory may be utilized to store content associated with a trigger.

In a further alternative, content may not be stored in the memory 116 of the STB 108 at all. Rather, the processor 120 may request an upstream server associated with the broadcast head end 104 for the content associated with the trigger when the trigger is actuated. Therefore, additional memory space on the STB 108 is not occupied by content that may or may not be viewed.

In accordance with at least some embodiments of the present invention, content associated with the trigger may be live content on a different channel. The trigger presented to the user may include a question asking the user if he/she would like to change channels. When the trigger is actuated, the live broadcast is changed from the original channel to the new channel associated with the trigger. Furthermore, the original channel may continue to be displayed to the user is a smaller portion of the display apparatus 140.

In the event the user decides that he/she does not wish to view the content associated with a particular trigger, the resume button 136 on the viewer control interface 128 may be activated to go back to the content that was previously being viewed. Thus, if the user was previously watching a television show when the trigger was activated, he/she may simply press the resume button 136 and the processor 120 will stop displaying the selected content and will resume displaying the previous content. Likewise, the user may navigate through different interactive music content, advertising content and live broadcast content using the arrows 134 in conjunction with the select 132 and resume 136 buttons.

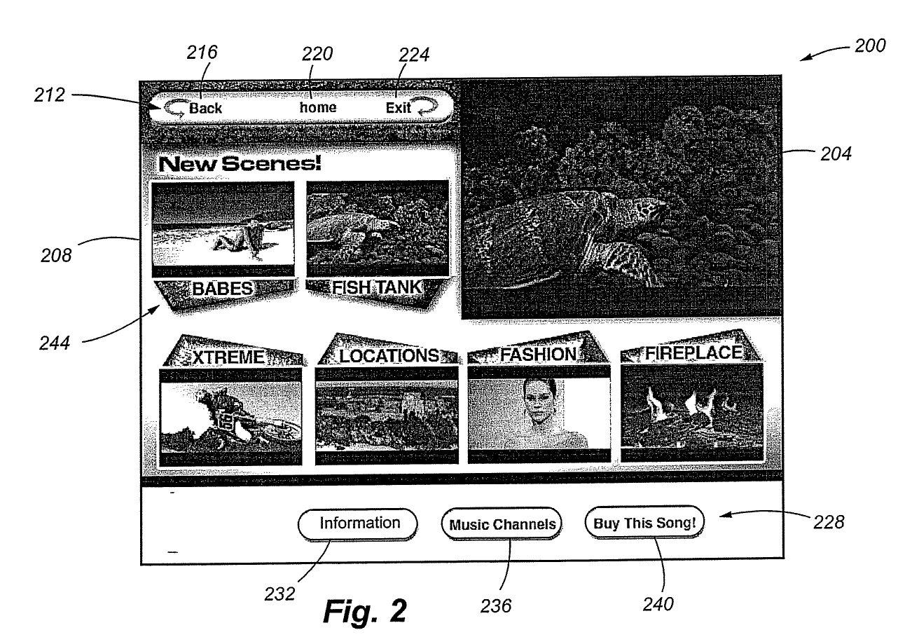

Referring now to FIGS. 2-5 the navigation of interactive music content will be described in accordance with embodiments of the present invention. Referring initially to FIG. 2, an interactive music menu 200 is shown in accordance with at least one embodiment of the present invention. The interactive music menu 200 generally comprises a first portion 204 for displaying a preview of image content and a second portion 208 for displaying various other menu items associated with the interactive music. The first portion 204, in one embodiment, generally occupies about a quarter of the display apparatus 140 and the second portion 208 generally comprises the remainder of the display apparatus 140 although various proportions can be allocated for different portions depending upon the type of content to be displayed therein.

The second portion 208 may further include a high level navigation bar 212 that allows a user to easily navigate through high levels of the interactive content hierarchy. For example, the high level navigation bar 212 may include a back selector 216, a home selector 220, and an exit selector 224. When the back selector 216 is selected, the content within the second portion 208 may return to content that immediately preceded the current content. The selection of the home selector 220 may change both the first and/or second portions 204 and 208 respectively back to their default (e.g., home) content. If the exit selector 224 is selected, then all content associated with the trigger, such as the interactive music menu, may be removed from the display device 140 in exchange for a live broadcast.

The second portion 208 can also include a low level navigation bar 228 that allows a user to navigate more defined levels of the interactive content hierarchy. The more defined lower levels of the content hierarchy may include selections of various songs, music channels, information advertisements, and purchase selections. As an example, the low level navigation bar 228 may include an information selector 232, a music menu selector 236, and a purchase selector 240. The activation of the purchase selector 240 may initiate the download of the currently playing song or some other selected song. As can be appreciated, fulfillment of the purchase of a song may prompt the song to be downloaded from a website account to the STB 108. Alternatively, the song purchase may be completed online and the user may be able to access and download the song from the Internet account at a later time. In one embodiment, the purchased song may be downloaded to memory 116 and stored there until it is retrieved using an external hardware device. After the song has been retrieved from memory 116, it may be deleted from memory 116 to make room for more songs or other content. In an alternative embodiment, after a song is purchased and stored in memory 116 it may be played (along with any images associated with the song) for the user on the display apparatus 140. This allows the user to chose the songs and/or music videos that lie/she wants to view on the display apparatus 140. There may be a limit on the member of songs that are purchased and stored in memory 116 at a given time. The limit may be determined by the size of the songs as well as the size of memory 116. If sufficient size is available on the memory 116, then a larger number of songs may be stored in memory 116 before they are required to be removed, erased, and/or transported to an external music playing device such as an MP3 device or the like.

In accordance with at least one embodiment of the present invention, a viewer is allowed to choose the type of image content that he/she wants to view while the selected music is playing. The image content may include static images, video images, and combinations thereof. The image content may be retrieved from the STB 108, a broadcast stream, and/or from an external device such as a video camera or the like. Accordingly, an image menu 244 may be provided as part of the second portion 208. The image menu 244 may include various image selections that are either recorded images or computer rendered images. Some of the images may be stored in a portion of memory 116 whereas others may be provided directly to the STB 108 from an upstream server upon request. Still other images may correspond to a live broadcast in some instances. The recorded images can vary in length and can be designed to replay after they have been through a single cycle. Thus, a viewer can watch the same recording continuously without needing to select the image every time it is done playing. Examples of the types of images that may be selected via the image menu include, without limitation, sport scenes, beach scenes, aquarium scenes, scenes from various locations, scenes from various fashion shows, a fireplace, and the like. In one embodiment, the user can upload image content from an external media device such as a portable memory, a portable music player, or a video camera to the STB 108. In the event that a viewers display apparatus 140 is not equipped with a STB 108 having an adequate memory 116, then images may be provided directly to the viewer through the STB 108. In one embodiment, if there is not an adequate memory 116, then computer rendered images are transmitted from the upstream server to the display apparatus 140 along with the selected music in an attempt to save bandwidth. However, if adequate bandwidth is available, then a live broadcast or other recorded set of images can be transmitted along with the selected music to the display apparatus 140.

An image from the image menu 244 may be displayed in the first portion 204 before final selection of the image. This way a viewer can preview a particular image along with the selected music before the image is finally selected and rendered to fill the entirety of the display apparatus 140.

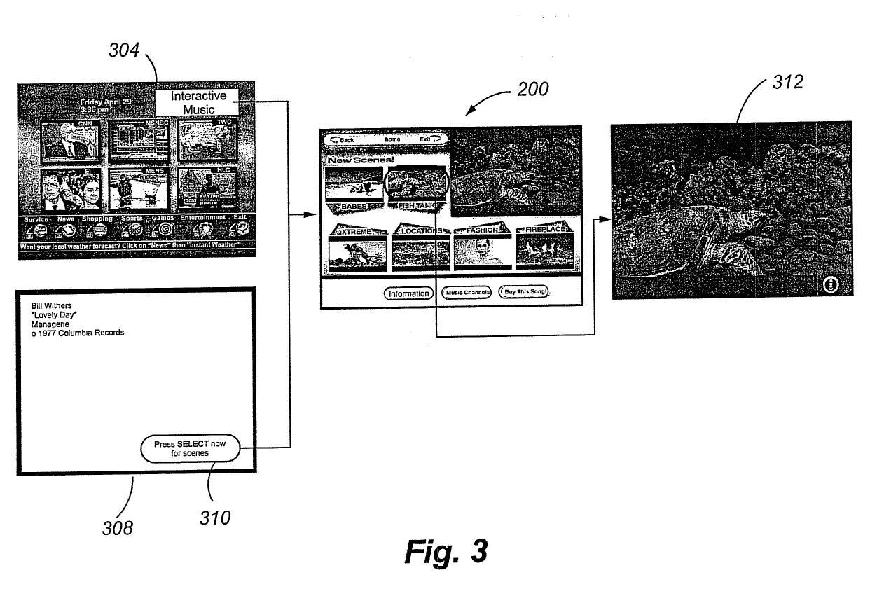

FIG. 3 depicts a flow chart for navigating and generating interactive music. Screens 304 and 308 may be used to access the interactive music menu 200. Screen 304 depicts a normal broadcast with a trigger 306 inserted therein in the form of an advertisement for interactive music. If the trigger 306 is selected, then the view in the display apparatus 140 will change from the broadcast shown in screen 304 to the interactive music menu 200. When the interactive music menu 200 is access from the screen 304, then a choice of music contents (e.g., selected songs, playlists, music channels, and music types) can be provided to a viewer before they are taken to the interactive music menu 200.

The interactive music menu 200 may alternatively be accessed via the music station screen 308. The music station screen 308 may include any known type of music display screen that is shown in association with an all music TV channel. A trigger 310 may be included in the music station screen 308 and if the trigger 310 is selected, then the screen will change to the interactive music menu 200.

If the interactive music menu 200 was accessed from the music station screen 308, then the same music associated with the music station screen 308 may be played for the viewer while the interactive music menu 200 is navigated. The viewer can then navigate various images and select one that he/she wants to view along with the current music. When the image is finally selected, it is displayed using the display apparatus 140 along with the selected music in the display screen 312. If the viewer wants to change images after final selection, then the resume button 136 can be activated causing the screen to return to the interactive music menu 200 and a different image can be selected.

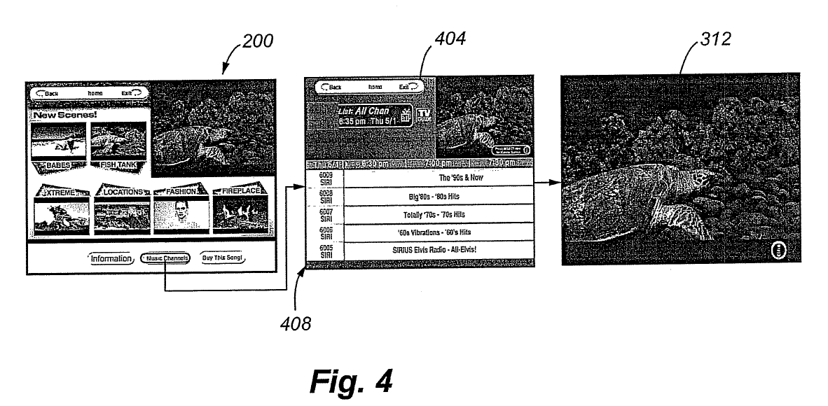

Referring now to FIG. 4, the selection of various music channels will be described in accordance with at least some embodiments of the present invention. Once the interactive music menu 200 has been accessed by the viewer either from the live broadcast or from a music channel, a user can select the channel selector 236. By selecting the channel selector 236, a music menu screen 404 is displayed that includes a music channel menu 408 in the second portion 208 of the screen. A viewer can navigate the music channel menu 408 and decide what music he/she wants to listen to. When a suitable music channel is selected the screen returns to the display screen 312 and the selected music can be played with the selected image.

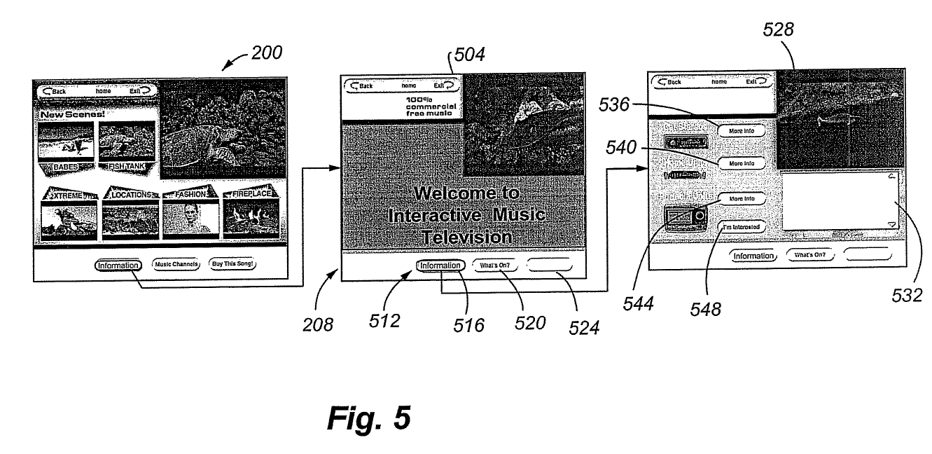

FIG. 5 depicts a flow chart for navigating interactive music information in accordance with at least some embodiments of the present invention. The information selector 232 can be accessed from the interactive music menu 200. Upon selection of the information selector 232, an interactive music information screen 504 is shown. The interactive music information screen 504 generally includes information or other advertisement media in the second portion of the screen 208. Also in the second portion of the screen 208 an information navigation bar 512 may be provided. The information navigation bar 512 may include an information selector 516, a what's on selector 520, and a purchase hardware selector 524.

When the information selector 516 is selected, a second information screen 528 is displayed. The second information screen 528 generally provides detailed information that can be related to services associated with the interactive music. For example, the second information screen 528 may include a car stereo more information selector 536, a home unit more information selector 540, a portable unit more information selector 544, and an interest selector 548 that can be selected to show an interest in a particular product. The more information selectors can be actuated to navigate the screen in a similar fashion to a web browser for a PC. When an information selector is selected, information related to the chosen selector is displayed in an information area 532.

In accordance with one embodiment, all of the information in the first 504 and second 528 information screens can be navigated while selected music is played and a selected image is displayed in the first portion 204 of the screen. In the event that the what's on selector 520 is selected, then a music and/or image menu may be displayed to the viewer as described above. If the purchase hardware selector 524 is selected, then an order may be placed for hardware related to the interactive music. The viewer can be asked for credit card information or another form of payment and various items can be purchased almost instantly using the TV interface. The purchase information can be transmitted (and usually encoded prior to transmission) to an upstream server that is responsible for handling such transactions. The purchased parts can be ordered and a delivery can be scheduled.

If a viewer selects the interest selector 548, then a more detailed information packet may be shipped to the viewer's address. This way a viewer can learn more about a product than what is shown in the information screens 504, 528. The viewer may also be provided with detailed information regarding the nearest hardware dealer in his/her area when the interest selector 548 is selected. The nearest dealer can be determined by comparing a zip code associated with the STB 108 to a list of hardware dealers. The closest dealer can then have their information provided to the viewer along with any other promotional information and/or a product or service catalog.

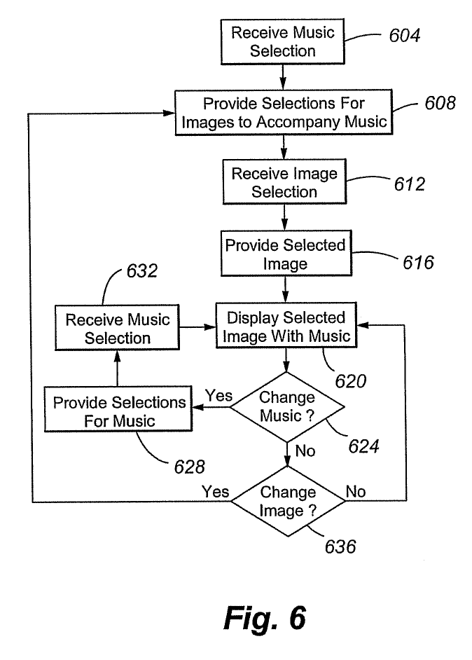

With reference now to FIG. 6, a method of providing an interactive music program will be described in accordance with at least some embodiments of the present invention. Initially, a selection for a particular song, type of music, or music channel is received either at the STB 108 or at an upstream server (step 604). The selection may be received in the form of a selected trigger that was either transmitted with a live broadcast or that was transmitted with a music channel that the viewer was listening to. When the trigger to view an interactive music channel is selected, an image menu is provided to the viewer using at least a portion of the display apparatus 140 (step 608). The viewer can then navigate the image menu using the viewer control interface 128. As the viewer navigates the image menu various previews of images can be displayed in the first portion 204 of the screen. The image content that may be included in the image menu may include still images and/or moving images such as video content.

Once the viewer has decided what image he/she would like to have displayed with the current music, then the viewer selects the image. The image selection is received either by the STB 108 and/or an upstream server and processed (step 612). The selected image is then retrieved from the appropriate source and provided to the viewer using, in most cases, all of the display apparatus 140. This way the viewer can look at the selected images and listen to the music as an integrated program (step 620). The viewer can continue to view the customized program until the program is either terminated and/or the viewer wants to re-customize the program.

In step 624, it is determined if the viewer would like to change the music of the program. This can be determined if the viewer presses the resume button 136 or a similar button/selector that indicates the viewer wants a music change. The viewer may alternatively press a channel change button that indicates a change in music channels is desired. If it is determined that the viewer wants a music change, then the viewer is provided with a music menu that outlines the songs, types of music, or music channels that are available to the viewer (step 628). Similar to the image menu, the viewer is allowed to navigate the menu until a selection is made. The selection is received by the STB 108 and/or an upstream server through either an activation of a trigger associated with the selected music or through the selection of a channel for the music (step 632). The newly selected music then replaces the old music and is integrated into the customized program and displayed along with the image to the viewer (step 620).

In step 636, it is determined if a change in images is desired. The viewer can initiate this change in a similar fashion to the way a music change can be initiated. In the event that the viewer wants to have an image change, the method returns to step 608 and the viewer is provided with an image menu. However, if no change in music or imagery is desired, then the viewer can continue to view the current program at step 620.

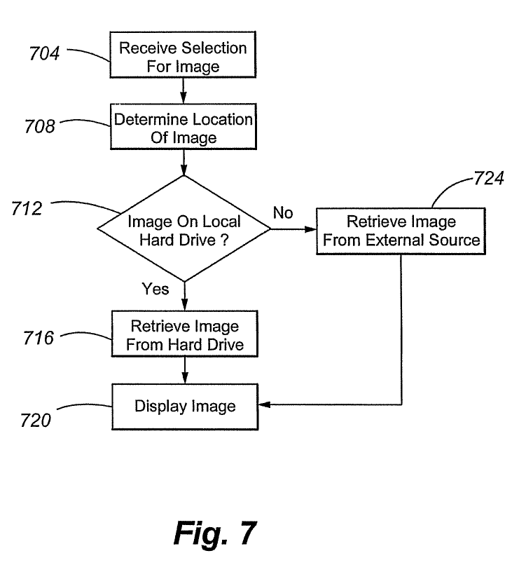

FIG. 7 depicts a method of retrieving a image content such as an image or set of images for display along with a selected song, type of music, or music channel in accordance with at least some embodiments of the present invention. The method begins when a selection for an image is received (step 704). As noted above, the image may be a set of recorded images (e.g., a video or slideshow), a set of computer rendered images, a live broadcast, or combinations thereof. Upon receiving the selection of the image, the processor 120 determines the location of the selected image (step 708). The selected image may be stored in memory 116 in which case a memory location is determined. The memory location for an image may be stored in association with each trigger. Therefore, when a trigger is selected, the memory location of the selected image is provided to the processor 120 along with the trigger. If no memory location is delivered along with the trigger, then it may be assumed that the selected image is not stored on a local hard drive. Thus, in step 712, depending upon whether a memory location is received with the trigger, it is determined if the selected image is stored on a local hard drive. In the event that a memory location is identified, the processor 120 can reference the memory location and retrieve the selected image from the memory 116 (step 716). The processor 120 then displays the image via the display apparatus 140 (step 720). As can be appreciated by one of skill in the art, images and other content can be sent to the memory 116 periodically from an external server or satellite uplink. Generally such content is delivered to the STB 108 during periods of inactivity. However, the content can also be delivered to the STB 108 during specified VBIs. The content stored on the memory 116 can be updated and replaced with new and different content depending upon the time of year or even the location or monitored viewing habits of the viewer.

On the other hand, if the selected image is not currently stored on memory 116 when the image is requested, then the image needs to be retrieved from an external source such as an upstream server similar type of broadcast device or an external memory device such as a camera or video camera. The STB 108 generates a request for the selected image and upon receiving the request the external source prepares the image and provides it back to the STB 108 (step 724). The selected image may be provided to the STB 108 during specified VBIs or may interrupt the live broadcast for delivery. In one embodiment, an image that requires a relatively small amount of bandwidth for transmission is transmitted from the external source to the STB 108. Images that require a relatively small amount of bandwidth may include static pictures and/or computer rendered images rather than recorded video images. These smaller images can be more easily transmitted during the VBI and thus will not interrupt the normal program. In an alternative embodiment, the transmission of an image to the STB 108 may be delayed until a period of inactivity or an interstitial of the broadcast. This way a larger image such as a set of recorded images (possibly having a higher resolution than a computer rendered image) can be transmitted and stored on memory 116. Once the selected image has been received from the external source, the image is displayed to the viewer (step 720). The image can be transmitted from memory 116 to the display apparatus 140 or may be directly displayed upon its receipt by the STB 108.

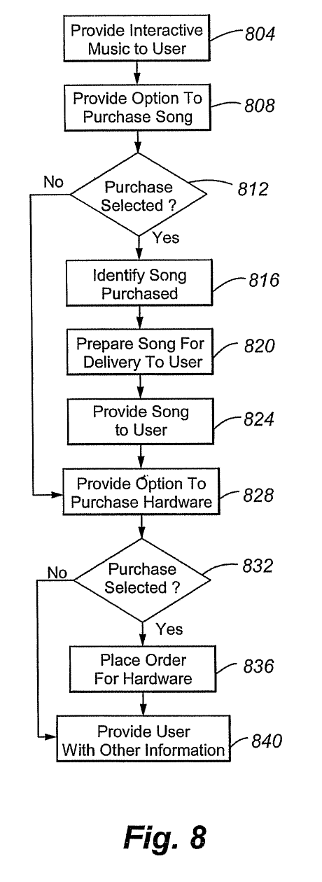

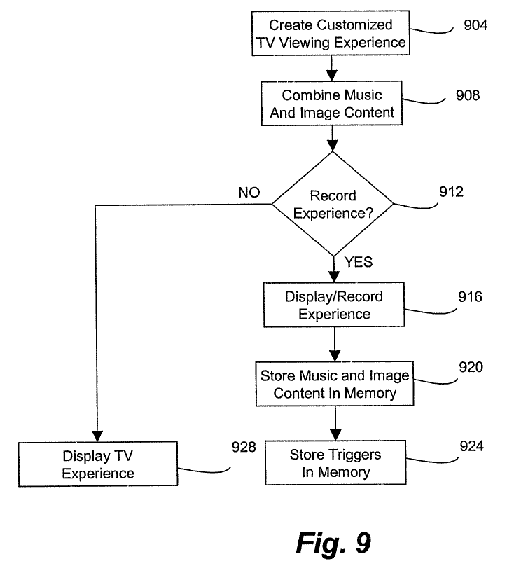

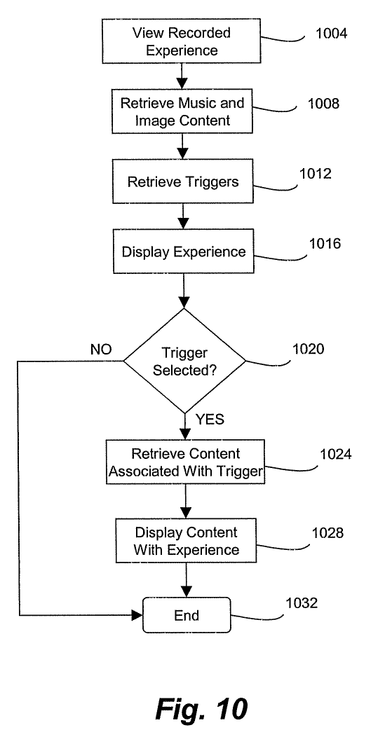

FIG. 8 depicts a method for purchasing various items using the interactive music program in accordance with embodiments of the present invention. Initially, the user can view and manipulate the interactive music application by navigating the various menus and selecting various triggers provided by those menus (step 804). As the user navigates the memos of the interactive music application, the user may be provided an option to purchase a song, such as the song that is currently playing, another song by the same artist, and so on (step 808). The option to purchase may be shown to the user in the form of the purchase selector 240. The method than continues to step 812 where it is determined if the user wants to purchase a song. If the user selects the purchase selector 240, then the trigger is activated for a song purchase. Once it is determined that the user wants to purchase a song, then the song(s) that the user wants to purchase are identified (step 816). This particular step may be performed by providing the user with a list of songs available for purchase or a more refined list relating to the song that is currently playing (e.g., a list of songs by the same artist). The user can select one or more of the songs that he/she would like to purchase. In an alternative embodiment, the activation of the purchase selector 240 may identify that the user wants to purchase the song currently playing. After selection of songs, the user may be asked to provide a form of payment for the songs (e.g., a credit card or the like).

After the songs to be purchased are identified, then the songs are prepared for delivery (step 820). In this step, the song format may be changed such that it can be transmitted from the broadcast head end 104 to the STB 108. Additionally, it may also be determined when the song is to be transmitted to the STB 108. For example, the song may be transmitted to the STB 108 during selected VBIs or during a period of inactivity. Once the song has been prepared for delivery then the song is transmitted to the STB 108 where it is stored in memory 116 (step 824). Once stored on memory 116, which may include a hard disk drive or a temporary memory location or buffer, the purchased song can then be transferred to an external device via the device interface 126. In one embodiment, after the song has been transferred it may be deleted from memory 116 to save room for other content. However, in an alternative embodiment, the song may be maintained in memory 116 for an indefinite amount of time where the user can play it at his/her leisure. Alternatively, the user may be directed to a website where the song has already been purchased and the user only needs to download the song from the website. The option of how a particular song is retrieved may be provided to the user and the execution of the song purchase may be completed in accordance with the user's selection.

Along with the option to purchase songs, the user may be provided with options to purchase other items such as hardware or other external devices that can be used to play songs, live broadcasts such as satellite broadcasts, artist performances in a number of different media types, retail products (e.g., shirts, hats, stickers, etc.), or other content. The user can be provided with this additional option whether he/she decided to purchase a song or not (step 828). The option to purchase hardware may be provided to the user in a similar fashion to the purchase selector 240 for the song. Namely, the user may be able to select a purchase selector associated with purchasing hardware.

In step 832, it is determined if a purchase of the hardware is desired. A user can request a purchase by activating the purchase selector associated with purchasing hardware. Of course, the user may also be provided with a selector identifying that no purchase is desired. If the user does not want to purchase any hardware, then the method continues to step 840 where the user may be provided with additional information related to the hardware and/or the software that is available for purchase. The additional information may be provided as part of an interactive advertisement or the user may be given information relating to a nearby dealer. However, if the user has identified that he/she would like to purchase some hardware, then an order for the hardware is placed (step 836). The request for an order may be transmitted from the STB 108 to an upstream server. The request may also be accompanied by user payment information such as a credit card number and expiration date. Once the request for an order is received, the server may automatically generate purchase order documents along with a delivery request. Confirmation of the purchase order can be transmitted to the user via known delivery methods such as email and the user then waits for delivery of the hardware. Alternatively, the user may be provided with a receipt, which can be taken to the nearest dealer in exchange for the purchased hardware. Once the purchase order has been completed, the user may be provided with additional information relating to either one of his/her purchases as well as additional information relating to other products and services (step 840).

Referring now to FIG. 9, a method of recording a customized music/image experience will be described in accordance with at least some embodiments of the present invention. The method begins when a user creates a customized TV viewing experience as described above (step 904). Specifically, the customized TV viewing experience may include music that was broadcast to the TV along with image content that was mixed with the music. Based upon the user's selection of image content that he/she would like to have displayed with the broadcast music, the music and image content are combined (step 908). Once the image content is selected, the user may be provided with an option to record the music/image experience (step 912). The music/image experience may be unique because the music is not necessarily controlled by the user but rather may be a part of a unidirectional broadcast from the head end 104. Accordingly, a user may wish to record the experience due to its uniqueness.

If the user decides to record the experience, the STB 108 begins displaying and recording the experience (step 916). The request to record the experience may be initiated by the user engaging the STB 108 with the viewer control interface 128. Upon receipt of the command, the processor 120 will begin forking the data stream being output to the display apparatus to the memory 116. This way a user can view the experience while it is simultaneously being recorded. The music and image content are stored in a portion of memory 116 such that they can be accessed at a later time (step 920). In an alternative embodiment, the recorded music and image content may be stored in an external memory location. Along with the music and image content any triggers embedded in the broadcast as a part of either the music or image content may be stored in memory 116 as well (step 924). The triggers generally correspond to address pointers that reference content either in memory 116 or in an external server. As noted above, the experience can be displayed while being recorded. However, in an alternative embodiment, the experience can be recorded first then displayed. In the event that the user decides not to record the experience, the customized music and image content are displayed to the user for their enjoyment (step 928).

With reference to FIG. 10, a method of displaying a recorded experience will be described in accordance with at least some embodiments of the present invention. The method is initiated when the user submits a request to view a recorded experience (step 1004). The recorded experience may be stored locally on memory 116 or at an external location. Upon receiving the request to view the recorded experience, the processor 120 retrieves the music and image content (step 1008). Along with the recorded music and image content, the processor 120 may also retrieve any triggers that were stored as a part of the experience (step 1012). Once retrieved, the processor 120 causes the experience to be displayed to the user via the display apparatus 140 (step 1016).

While the experience is being displayed a trigger may be presented to the user (step 1020). When the experience was recorded the trigger pointed to a particular memory location that was either local to the STB 108 or separate therefrom. The memory location contained content associated with the trigger. Examples of such content could include product offerings, short form advertisements, long form advertisements, information, song/image purchase options, and so on. During recording the content stored in the memory location may have corresponded to a first content. However, after the experience was recorded, the content may change to a second different content. In other words, the product offering, short form advertisement, long form advertisement, information, song/image purchase options, or the like may have been changed. If the user selects the trigger, then the content stored in the address associated with the trigger is retrieved (step 1024). The content may be the same content that was stored in association with the trigger when the experience was recorded. In an alternative embodiment, however, the content retrieved may differ from the content originally associated with the trigger.

Once the content has been retrieved by the processor 120, the content associated with the trigger is displayed to the user through the display apparatus 140 (step 1028). This allows the user to either view the experience how it was recorded or in a different way from when it was recorded depending on whether the content has been changed. After the content associated with the trigger is displayed to the user or the user does not select the trigger he/she may continue to view the experience until it ends (step 1032).

The foregoing discussion of the invention has been presented for purposes of illustration and description. Furthermore, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best modes presently known of practicing the invention and to enable others skilled in the art to utilize the invention in such, or in other embodiments, and with the various modifications required by their particular application or use of the invention. It is intended that the appended claims be construed to include alternative embodiments to the extent permitted by the prior art.

What is claimed is:

1. A method of providing an interactive music program, comprising:
receiving notification that a first trigger associated with a first music content has been actuated;
receiving notification that a second trigger associated with a first image content has been actuated;
retrieving the first music content and the first image content;
combining the first music content and the first image content into a single program; and
causing the single program to be displayed to a viewer of a display apparatus.

2. The method of claim 1, further comprising:
providing a menu of music content via the display apparatus, wherein the menu of music content comprises a plurality of music choices each having a trigger associated therewith; and
allowing the viewer to select the first music content from the plurality of music choices.

3. The method of claim 2, wherein the plurality of music choices comprises at least one of a number of songs, a member of types of music, and a number of music channels.

4. The method of claim 1, further comprising:
providing a menu of image content via the display apparatus, wherein the menu of image content comprises a plurality of image choices each having a trigger associated therewith;
allowing the viewer to select the first image content from the plurality of image choices.

5. The method of claim 4, wherein the plurality of music choices comprises at least one of a set of recorded images, a set of computer rendered images, and a live broadcast.

6. The method of claim 5, wherein the at least one of a set of recorded images, a set of computer rendered images, and a live broadcast are uploaded by a user from an external device.

7. The method of claim 1, wherein retrieving the first music content and the first image content comprises:
determining whether the first music content and the first image content are stored in a local memory;
performing one of the following substeps:
(i) in the event that the first music content and the first image content are stored in a local memory, determining an address of the first music content and the first image content in the local memory and delivering the first music content and the first image content from the determined memory address; and
(ii) in the event that at least one of the first music content and the first image content are not stored in the local memory, requesting the at least one of the first music content and the first image content that is not stored in the local memory to be delivered from an external source.

8. The method of claim 1, wherein the display apparatus comprises a television.

9. The method of claim 1, further comprising:
receiving notification that a trigger associated with a request to purchase the first music content has been selected;
downloading the first music content onto a local memory associated with the display apparatus from an external source; and
storing the first music content on the local memory.

10. The method of claim 9, wherein the first music content is downloaded during Vertical Blanking Intervals (VBIs) of a broadcast.

11. The method of claim 9, further comprising:
uploading the first music content from the local memory to an external device; and
removing the first music content from the local memory.

12. The method of claim 9, wherein the local memory comprises a hard disk drive associated with a digital video recorder (DVR).

13. The method of claim 1, further comprising:
receiving notification that a third trigger has been actuated that identifies that the first music content is to be replaced by a second music content;
retrieving the second music content;
replacing the first music content with the second music content;
combining the second music content with the first image content into a new single program; and
causing the new single program to be displayed to a viewer of the display apparatus.

14. The method of claim 1, further comprising:
receiving notification that a third trigger has been actuated that identifies that the first image content is to be replaced by a second image content;
retrieving the second image content;
replacing the first image content with the second image content;
combining the second image content with the first music content into a new single program; and
causing the new single program to be displayed to a viewer of the display apparatus.

15. The method of claim 1, further comprising:
displaying the first image content on a first portion of the display apparatus; and
displaying a second content on a second portion of the display apparatus, wherein the second content comprises an interactive medium.

16. The method of claim 15, wherein the second content comprises at least one of a short form advertisement, a long form advertisement, a broadcast, a static advertisement page, and a personalized advertisement.

17. The method of claim 1, wherein displaying comprises at least one of visually displaying and audibly displaying the single program to a viewer.

18. A computer readable medium comprising processor executable instructions for performing the method of claim 1.

19. An enhanced television system for delivering interactive music content to a viewer, comprising:
a receiver adapted to receive music content and image content from an external source;
a first trigger associated with a first music content, wherein the first trigger provides the viewer an option to choose the first music content;
a second trigger associated with a first image content, wherein the second trigger provides the viewer an option to choose the first image content;
a processor for combining the first music content with the first image content to produce a single program; and
a display apparatus operable to present the single program to the viewer.

20. The system of claim 19, further comprising a memory for storing the received music content and image content prior to display of such content.

21. The system of claim 20, wherein the memory comprises a hard disk drive.

22. The system of claim 20, further comprising a device interface operable to connect an external device to the memory such that at least one of music content and image content stored on the memory can be transferred to the external device.

23. The system of claim 22, wherein the device interface comprises a common control interface including at least one of a Universal Serial Bus (USB) port, a serial port, and a parallel port.

24. The system of claim 19, wherein the processor is further operable to provide a menu of music content to the display apparatus for display to a viewer of the display apparatus, wherein the menu of music content comprises a plurality of music choices each having a trigger associated therewith.

25. The system of claim 24, wherein the plurality of music choices comprises at least one of a member of songs, a number of types of music, and a number of music channels.

26. The system of claim 19, wherein the processor is further operable to provide a menu of image content to the display apparatus for display to a viewer of the display apparatus, wherein the menu of image content comprises a plurality of image choices each having a trigger associated therewith.

27. The system of claim 26, wherein the plurality of music choices comprises at least one of a set of recorded images, a set of computer rendered images, and a live broadcast.

28. The system of claim 19, wherein the display apparatus comprises a television.

29. The system of claim 19, wherein the first trigger comprises at least one of a Universal Resource Locator (URL) that provides an address from which interactive content may be downloaded and an attachment of interactive content.

30. The system of claim 19, wherein the second trigger comprises at least one of a Universal Resource Locator (URL) that provides an address from which interactive content may be downloaded and an attachment of interactive content.

31. The system of claim 30, wherein the address comprises a memory address.

32. A method for providing an interactive music program via a television, comprising:
receiving a live broadcast comprising at least a first music content;
providing a viewer of the television an option to purchase the first music content;
receiving a request from the viewer to purchase the first music content;
requesting that a copy of the first music content be transmitted along with the broadcast to a memory associated with the television;
receiving the copy of the first music content at the memory; and
storing the first music content on the memory.

33. The method of claim 32, wherein the live broadcast comprises a music channel.

34. The method of claim 32, further comprising:
providing a connection between the memory and an external device;
causing the first music content to be transferred from the memory to the external device; and
after the first music content has been transferred to the external device, erasing the first music content from the memory.

35. The method of claim 32, wherein the copy of the first music content is transmitted during a Vertical Blanking Interval (VBI) of the broadcast.

36. The method of claim 32, wherein broadcast further comprises a first image content that is displayed along with first music content.
